(19) United States
(12) Patent Application Publication
(10) Pub. No.: US 2008/0179855 A1
(43) Pub. Date: Jul. 31, 2008

(54) Systems and Methods for Propelling a Wheelchair

(75) Inventors: Yong Tai Wang, Marietta, GA (US); Weerawat Limroongreungrat, Norcross, GA (US); Francis Michael Edel, Kennesaw, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: GEORGIA STATE UNIVERSITY RESEARCH FOUNDATION, INC., Atlanta, GA (US)

(21) Appl. No.: 11/627,502

(22) Filed: Jan. 26, 2007

(51) Int. Cl. B62M 1/04

(52) U.S. Cl. 280/252

(57) ABSTRACT

In one embodiment, a wheelchair comprises an armature configured to be manipulated by a user of the wheelchair during a propulsion stroke to drive at least one wheel of the wheelchair, wherein the armature is extensible such that its length increases as it is moved away from the wheelchair user. In another embodiment, a wheelchair comprises a gear mechanism configured to drive a wheel of the wheelchair in at least one direction, the gear mechanism including an electronically-controlled actuator that is configured to control a direction in which the wheel can be driven.

### BACKGROUND

Conventional wheelchairs are normally propelled forward by the wheelchair user by grasping push rims mounted to the main wheels of the wheelchair and pushing the push rims forward to cause the wheels to rotate. To maximize forward travel, the user must reach behind his or her torso and force the wheels to rotate from an unfavorable anatomical position. Such an action places undue stress on the user's shoulders and requires a relatively large amount of force to be exerted. When the propelling movement is repeatedly performed, injury and/or pain can be inflicted upon the user's shoulders, even in cases in which the user has relatively good upper body strength. For those users who do not have good upper body strength, for example due to disease, infirmity, or injury, a further problem exists in terms of mustering the strength needed to propel the wheelchair.

In view of the problems associated with conventional wheelchairs, various mechanisms have been developed to assist wheelchair users in propelling their wheelchairs. In one such mechanism, an armature is provided that is connected to the axis of the main wheels that permits the user to propel the wheelchair by pushing the armature instead of having to push the push rims. Although that mechanism comprises an improvement over conventional wheelchairs given that the user no longer must reach behind his or her body to begin the propulsion action, propulsion is still somewhat awkward given that the armature can only be rotated about the wheel axis. In particular, since the armature is connected to the axis of the main wheels and further given that the armature simply comprises one or more tubes that radially extend from the axis, the user begins pushing from a first, relatively high position, and finishes in a second, relatively low position tracing a downward arc during the forward stroke. Such a motion is not anatomically ideal given that the user must unnaturally both push the armature forward and downward through the stroke.

Another disadvantage of the above-described propelling mechanism relates to leverage. Specifically, the amount of leverage that the user has over rotation of the main wheels is limited by the lengths of the armature tubes, which are limited by the distance between the axis of the wheels and the desired starting hand position of the propulsion stroke. In particular, to ensure that the starting position of the stroke generally coincides with the shoulders of the user, only a limited amount of leverage is available to the user, even though the forward range of motion of the user would permit for greater leverage.

In view of the above, it would be desirable to have a propulsion mechanism for a wheelchair that overcomes one or more of the aforementioned disadvantages.

### SUMMARY

Disclosed are systems and methods for propelling a wheelchair. In one embodiment, a wheelchair comprises an armature configured to be manipulated by a user of the wheelchair during a propulsion stroke to drive at least one wheel of the wheelchair, wherein the armature is extensible such that its length increases as it is moved away from the wheelchair user.

In another embodiment, a wheelchair comprises a gear mechanism configured to drive a wheel of the wheelchair in at least one direction, the gear mechanism including an electronically-controlled actuator that is configured to control a direction in which the wheel can be driven.

### BRIEF DESCRIPTION OF THE DRAWINGS

The components in the drawings are not necessarily to scale, emphasis instead being placed upon clearly illustrating the principles of the present disclosure. In the drawings, like reference numerals designate corresponding parts throughout the several views.

FIG. 1 is perspective view of an embodiment of a wheelchair.

FIG. 2 is a perspective view of a portion of an embodiment of an armature of the wheelchair of FIG. 1.

FIG. 3 is a perspective exploded view of an embodiment of a gear mechanism of the wheelchair of FIG. 1.

FIG. 4 is a front perspective view of an embodiment of a controller of the wheelchair of FIG. 1.

FIG. 5 is a rear perspective view of the controller of FIG. 4.

FIG. 6 is a perspective view of a portion of the gear mechanism of FIG. 3.

FIGS. 7A-7C are side views of a portion of the gear mechanism of FIG. 3 depicting a toothed member of the mechanism in different orientations to effect different types of wheelchair motion.

FIGS. 8A-8C are side views of the wheelchair of FIG. 1 depicting manipulation of an armature to propel the wheelchair in a forward direction.

### DETAILED DESCRIPTION

Disclosed are systems and methods for propelling a wheelchair. In some embodiments, an armature is provided that comprises extensible arms that enable the user to push, or pull, the armature in a substantially horizontal direction throughout the propulsion stroke such that the wheelchair can be propelled using a more natural motion. By way of example, the arms of the armature comprise two segments that are pivotally connected to each other at a hinge such that the arms can begin at a first position in which they form a relatively small angle between each other and finish at a second position in which they form a relatively large angle between each other to extend the distance between the user's hands and the axis of the main wheels through the forward stroke. In addition to enabling a more horizontal movement in which the height of the starting position is nearly equal to the height of the finishing position, greater leverage over the wheels is provided due to lengthening of the armature arms.

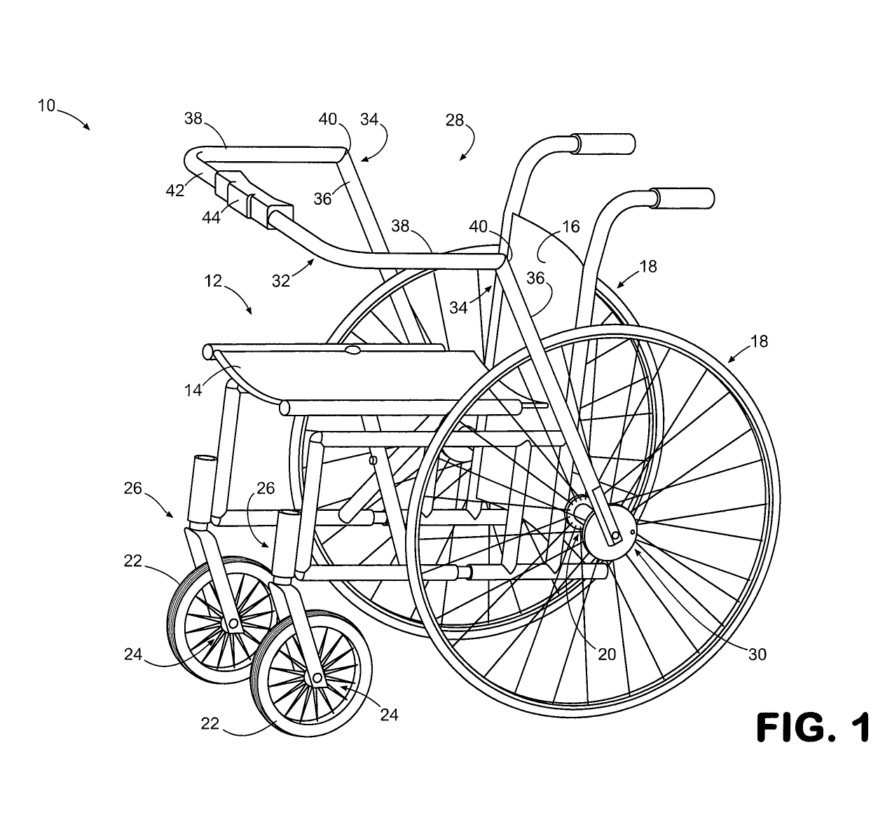

FIG. 1 illustrates an embodiment of a wheelchair 10 that includes a mechanism for propelling the wheelchair both in the forward and rearward directions, as well as turning the wheelchair. As indicated in FIG. 1, the wheelchair 10 generally comprises a frame 12 comprised of various sections of tubing. The frame 12 forms a chair that generally comprises a seat 14 and a backrest 16. Mounted to the frame 12 are main wheels 18. Each of the main wheels 18 can rotate relative to the frame 12 due to axles 20 that connect the wheels to the frame. Also mounted to the frame 12 are secondary front wheels 22 that can rotate about their own axes 24 and pivot due to pivot axes of their mounting brackets 26.

The wheelchair 10 further comprises a propulsion mechanism, generally identified by reference numeral 28. The propulsion mechanism 28 includes gear mechanisms 30 that are positioned adjacent each of the wheel axes 20. In addition, the propulsion mechanism 28 includes an armature 32 that is associated with the gear mechanisms 30. The armature 32 includes lateral arms 34 that are mounted to the wheel axes 20. As indicated in FIG. 1, the arms 34 each comprise a first arm segment 36 and a second arm segment 38 that is pivotally connected to the first arm segment at a hinge 40. In at least some embodiments, the armature 32 further includes a crossbar 42 that extends between the second arm segments 38 of each arm 34 so as to connect the two arms to each other and limit the arms to synchronous movement. Provided on the crossbar 42 is a controller 44 that can be used to control the propulsion mechanism and select the various directions in which the user would like the wheelchair 10 to travel when propelled.

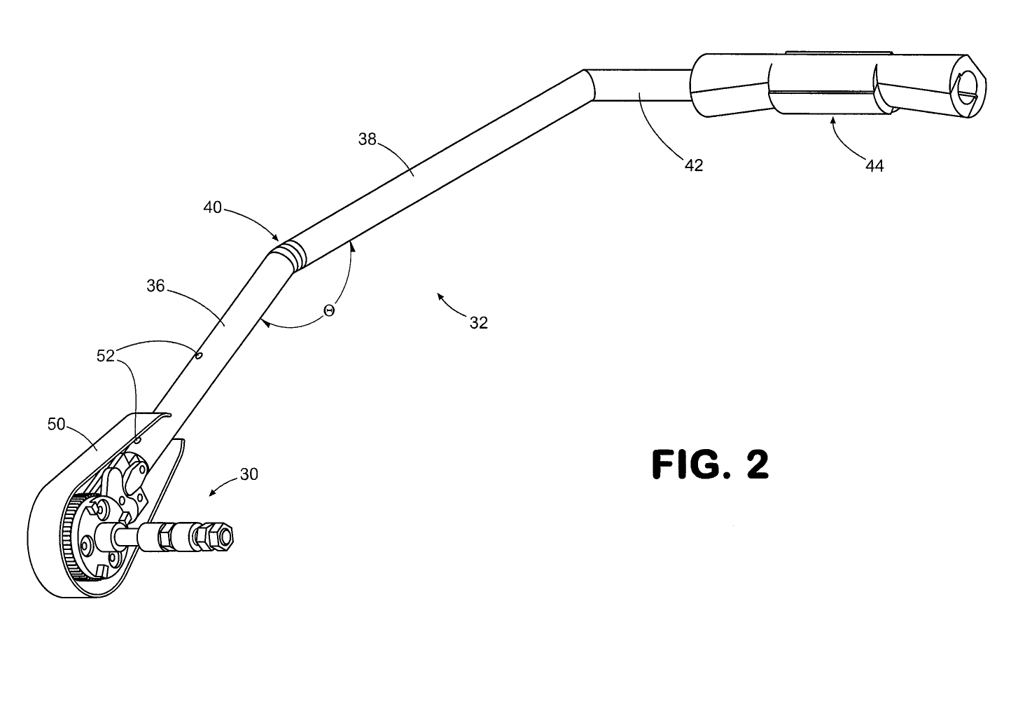

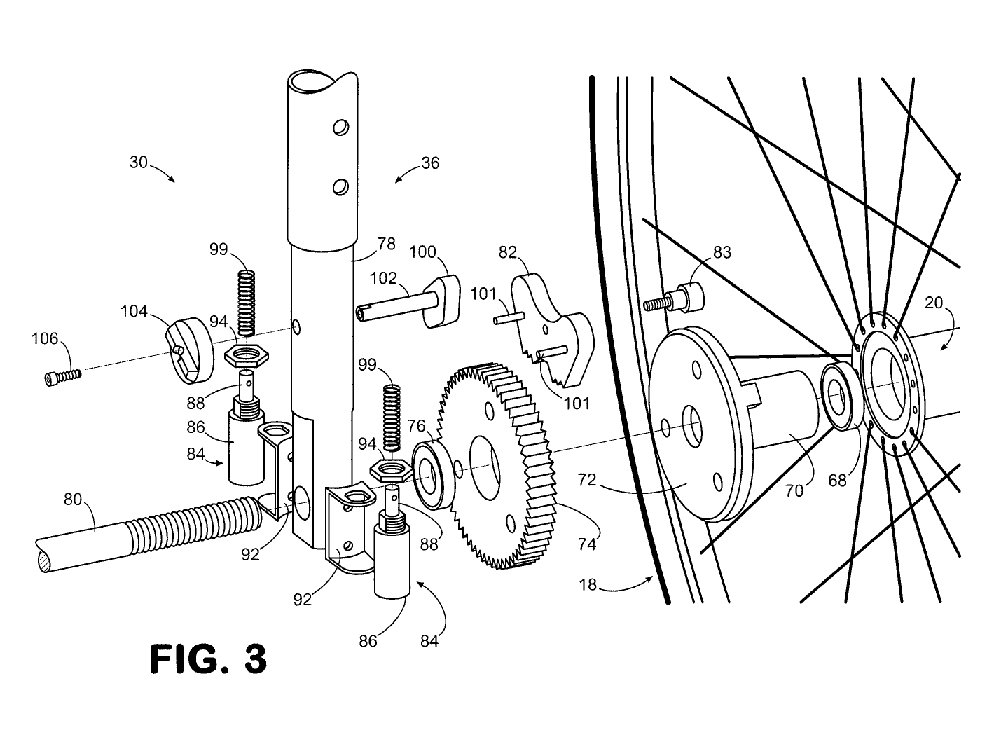

FIG. 2 illustrates a portion of the armature 32 and one of the gear mechanisms 30. More particularly, illustrated is a left portion of the armature 32 and the left gear mechanism 30. As indicated in FIG. 2, the gear mechanism 30 comprises various components, described in detail in regard to FIG. 3, that are contained within a housing 50. In FIG. 2, the armature 32 is shown in the fully extended position, such as when the armature has been pushed to the maximum extent forward during a forward propulsion stroke. As shown in the figure, the first arm segment 36 and the second arm segment 38 form a relatively large angle Θ between each other that is less than 180°. In such a case, the length between the distal end of the second arm segment 38 and the main wheel axle 20 (not shown) is nearly the sum of the lengths of the first and second arm segments 36, 38. As described below, such a length provides a relatively large amount of leverage to the user in propelling the wheelchair 10. Because the angle Θ does not reach or surpass 180°, however, locking or binding of the first and second arm segments 36, 38 is avoided, as when the user has fully extended the armature 32 and wishes to then retract the armature by pulling the armature back toward his or her body. By way of example, the angle Θ at full extension of the armature 32 is approximately 170° to 175°.

The hinge 40 can comprise a simple hinge that limits relative movement of the first and second arm segments 36, to a single plane. In alternative embodiments, however, the hinge 40 can permit a greater range of relative motion.

As is further illustrated in FIG. 2, the first arm segment 36 comprises adjustment holes 52 that are adapted to receive detents or fasteners (not shown) to enable adjustment of the length of the first arm segment to suit the size of the wheelchair user. In such a case, the first arm segment 36 can comprise an outer tube (shown) and an inner tube or shaft (see FIG. 3) that can be connected together in various relative positions such that the outer tube can telescope relative to the inner shaft to increase or reduce the length of the first arm segment.

FIG. 3 illustrates an embodiment of a gear mechanism 30 in an exploded view. As shown in FIG. 3, the gear mechanism 30, from right to left, includes first and second spacers 68 and 70. In addition, the gear mechanism 30 includes a mounting plate 72 that secures both to a main wheel 18 of the wheelchair as well as to a drive gear 74. By way of example, the mounting plate 72 mounts to the drive gear 74 with threaded fasteners such as bolts (not shown). Continuing right to left, the gear mechanism 30 further comprises a third spacer 76 that separates the drive gear 74 from the first arm segment 36. In the embodiment of FIG. 3, shown is an inner shaft 78 of the first arm segment 36, which was first mentioned in relation to FIG. 2. Also shown in FIG. 3 is a bolt 80 that extends through the other components described above to maintain the relative positions of those components.

Further included in the gear mechanism 30 is a toothed member 82 having teeth adapted for mating with the teeth of the drive gear 74. The toothed member 82 pivotally 110 mounts to the first arm segment 36 with a fastener 83. As is described later, the toothed member 82 and the drive gear 74 together function as a ratchet device in which the drive gear acts as a gearwheel and the toothed member acts as a pawl.

The gear mechanism 30 also includes actuators 84 that are used to actuate the toothed member 82 to enable the drive gear 74 to selectively travel only in one of two directions, forward and reverse. In the embodiment of FIG. 3, the actuators 84 comprise solenoid actuators that are electrically activated in response to inputs received with the controller 44 (FIG. 1). The actuators 84 each comprise a body or housing 86 from which a shaft 88 extends. Activation of the actuators 84 causes the shafts 88 to extend or retract, as desired. As indicated in FIG. 3, the actuators 84 can be secured to first arm segment 36 with brackets 92 and nuts 94.

Once secured to the inner shaft 78, each actuator 84 can be activated to extend its shaft 88 and adjust the position of the toothed member 82. In particular, springs 99 provided on top of the actuator shafts 88 can urge pins 101 that extend from a back side of the toothed member 82 to pivot the toothed member and control rotation of the drive gear 74.

In addition, the gear mechanism 30 includes a manual override member 100 that mounts to the first arm segment 36 with its own shaft 102 and connects to a knob 104 with a fastener 106. The manual override member 100 can be used to adjust the orientation of the toothed member 82 in situations in which one or both of the actuators 84 is/are non-functional, either due to malfunction of the actuator(s) or the inability to provide control signals to the actuator(s). In such a case, the override member 100 can be toggled to one direction or the other by manually turning the knob 104.

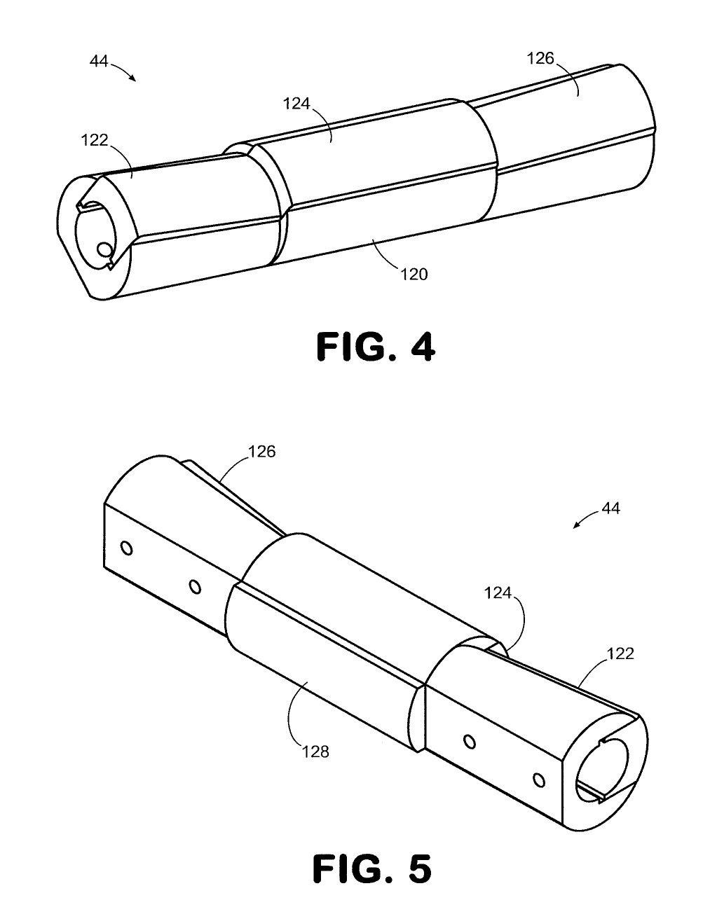

FIGS. 4 and 5 illustrate an embodiment of the controller 44 that is used to control the gear mechanism 30 and, more particularly, the actuators 84 (FIG. 3). More particularly, FIG. 4 shows the front side of the controller 44 that faces the wheelchair user, and FIG. 5 shows the back side of the controller that faces away from the wheelchair user. Beginning with FIG. 4, the controller 44 generally comprises a housing 120. Provided on the housing 120 are a left control element or button 122, a center control element or button 124, and a right control element or button 126, each of which is associated with at least one internal electrical microswitch (not shown). The center button 124 is used to cause the gear members 82 of both gear mechanisms 30 to engage their respective drive gears 74 in a manner in which the wheels 18 will be forced to turn in the forward direction when the armature 32 is pushed forward by the user.

The left button 122 is used to cause the wheelchair 10 to turn left when propelled. In some embodiments, two types of left turns can be effected. In such a case, a first or “normal” left turn is made by pressing the outer end of the left button 122. In such a case, the right toothed member 82 will engage its drive gear 74 in a manner in which the right wheel 18 will be forced to turn in the forward direction when the armature 32 is pushed forward by the user. The left toothed member 82, however, will not engage its drive gear 74 at all such that the left wheel 18 is free to rotate (idle) in either direction. A second or “stationary” left turn can be made by pressing the inner end of the left button 122. In such a case, the right toothed member 82 will again engage its drive gear 74 in a manner in which the right wheel 18 will be forced to turn in the forward direction when the armature 32 is pushed forward by the user. The left wheel 18, however, is at least prevented from moving in the forward direction so that a tighter turn can be achieved. In some embodiments the left wheel 18 is prevented from moving forward using a braking mechanism (not shown), such as a braking mechanism similar to those used on conventional bicycles.

The right button 126 can be used in similar manner as the left button 124. Therefore, in some embodiments, both normal and stationary right turns can be selected with the right button 126. When two types of left and right turns are possible, each of the left and right buttons 122 and 124 can comprise two internal microswitches, one that registers when the outer end of the button is pressed and another that registers when an inner end of the button is pressed.

Turning to FIG. 5, a second center button 128 is provided that, when selected, causes the gear members 82 of both gear mechanisms 30 to engage their respective drive gears 74 in a manner in which the wheels 18 will be forced to turn in the rearward direction when the armature 32 is pulled backward by the user. As with the other buttons, the second center button 128 is associated with an internal electrical microswitch (not shown).

In view of the above, the controller 44 can be used to effect forward motion, rearward motion, normal and tight left turns, and normal and tight right turns. In addition, a “neutral” state can be achieved when both center buttons 124 and 128 are pressed. In such a case, neither of the toothed members 82 engage their drive gear 74 such that both wheels 18 are free to rotate (idle) in either direction.

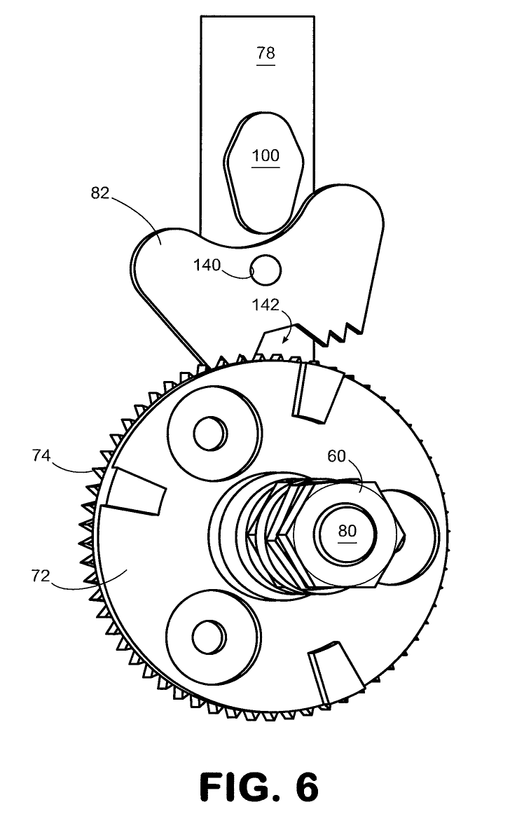

FIG. 6 depicts manipulation of the toothed member 82 through use of the actuators 84 (FIG. 3). As shown in FIG. 6, the toothed member 82 can be pivoted about its axis. In the example of FIG. 6, the toothed member 82 has been pivoted counter-clockwise such that its teeth 142 mesh with teeth of the drive gear 74. Due to the dimensions of the toothed member 82 and its abutment with the drive gear 74, the toothed member cannot rotate further in the counter-clockwise direction. As a consequence, the drive gear 74 cannot rotate clockwise relative to the toothed member 82. In such a case, when the armature 32 is pushed in the left direction of the figure, the drive gear 74 will be forced to rotate counter-clockwise and drive its associated wheel 18 (not shown) counter-clockwise. However, when the armature 32 is then pulled in the right direction of the figure, the drive gear 74 will not be forced to rotate clockwise due to the toothed member skipping across or ratcheting over the teeth of the drive gear. Therefore, operation of propulsion mechanism 28 is similar to operation of a ratchet wrench in which an element is positively driven in a first direction by rotation of a lever arm, but not driven in the opposite direction by opposite rotation of the lever arm.

The action described above in relation to FIG. 6 is enabled by the actuators 84 (see FIG. 3). In FIG. 6, the leftmost actuator shaft 88 has been placed in a retracted position, while the rightmost actuator shaft 88 has been placed in an extended position. Through such actuation, the spring 99 of the rightmost actuator shaft 88 moves the associated toothed member pin 101 to a relatively high position to, in turn, shift the orientation of the toothed member 82 to that shown in FIG. 6. Because springs 99 are used to position to the toothed member 82, the toothed member is free to skip over the teeth of the drive gear 74 in the return direction as described above. As also described above, the actuators 84 are controlled with signals input using the controller 44. In particular, signals travel from the controller 44 along wires (not shown) to appropriately activate the actuators 84 and move the fasteners 92.

With continued reference to FIG. 6, the wheel 18 can be driven in an opposite direction by shifting the positions of the shafts 88 such that the leftmost actuator shaft is placed in the high position and the rightmost actuator shaft is placed in the low position. Notably, when both shafts 88 are moved to a middle position (not shown), the toothed member 82 is maintained in a neutral position due to the presence of the springs 99 such that none of the teeth 142 can engage the drive gear 74. In such a case, the drive gear 74 and its associated wheel 18 are free to rotate in either direction (idle).

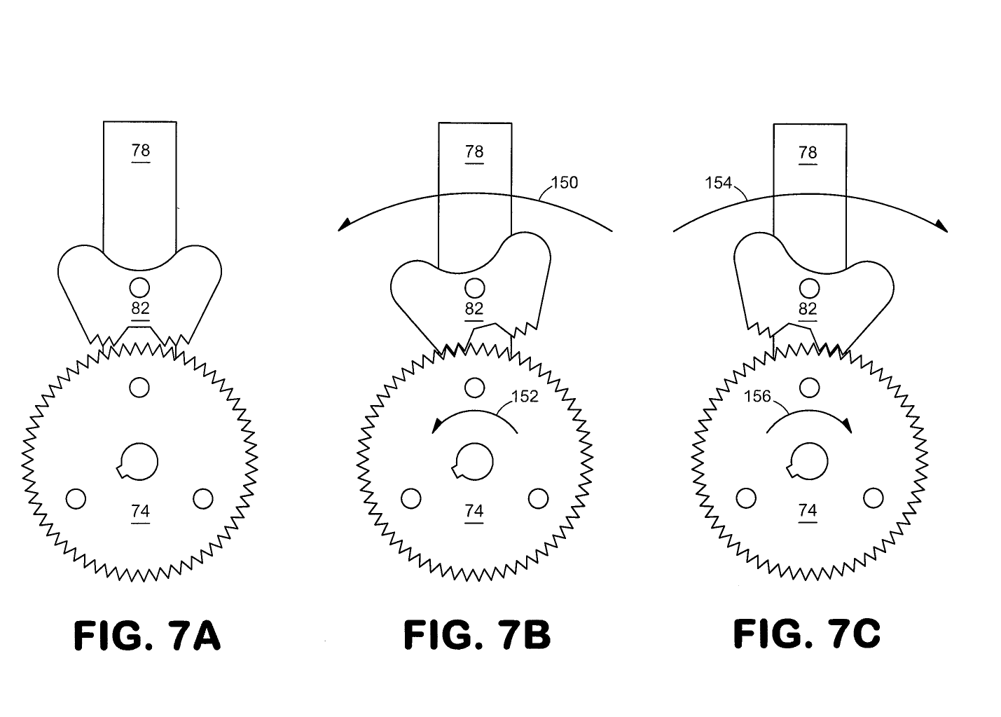

FIGS. 7A-7C show various relative positions of a toothed member 82 and a drive gear 74. In those figures, it is assumed that the toothed member 82 and the drive gear 74 are those of the left-side gear mechanism 30 on the left side of the wheelchair 10. In FIG. 7A, the toothed member 82 is placed in a neutral position (both actuators 84 in the middle position) in which the toothed member cannot engage the drive gear 74. In such a case, the operation of the armature 32 in either direction (i.e., forward or backward) will not drive the wheel 18 in either direction. In FIG. 7B, the toothed member 82 is, as in FIG. 6, pivoted counter-clockwise (left-side actuator low and right-side actuator high) such that forward motion of the armature 32, indicated by arrow 150, drives the drive gear 74 in forward direction, indicated by arrow 152. In FIG. 7C, the toothed member 82 is pivoted counter-clockwise (left-side actuator high and right-side actuator low) such that rearward motion of the armature 32, indicated by arrow 154, drives the drive gear 74 in rearward direction, indicated by arrow 156.

From FIGS. 7A-7C it can be appreciated that the various types of movements of the wheelchair 10 are possible through combinations of selected orientations for the left and right gear mechanisms 30. For example, if both gear mechanisms 30 of the wheelchair are oriented as shown in FIG. 7B, the wheelchair 10 can be driven forward by pushing the wheelchair armature 32 forward. When the armature 32 is pulled back, however, the wheels 18 are not driven backward through the above-described ratcheting action. To cite another example, if the gear mechanism 30 on the left side of the wheelchair is oriented as shown in FIG. 7B but the gear mechanism 30 on the right side of the wheelchair is oriented as shown in FIG. 7A, the left wheel 18 will be driven forward by pushing the armature 32 forward but the right wheel will idle, thereby effecting a normal right turn. The other gear mechanism orientations necessary to effect the other wheelchair movements will be appreciated by those having ordinary skill in the art.

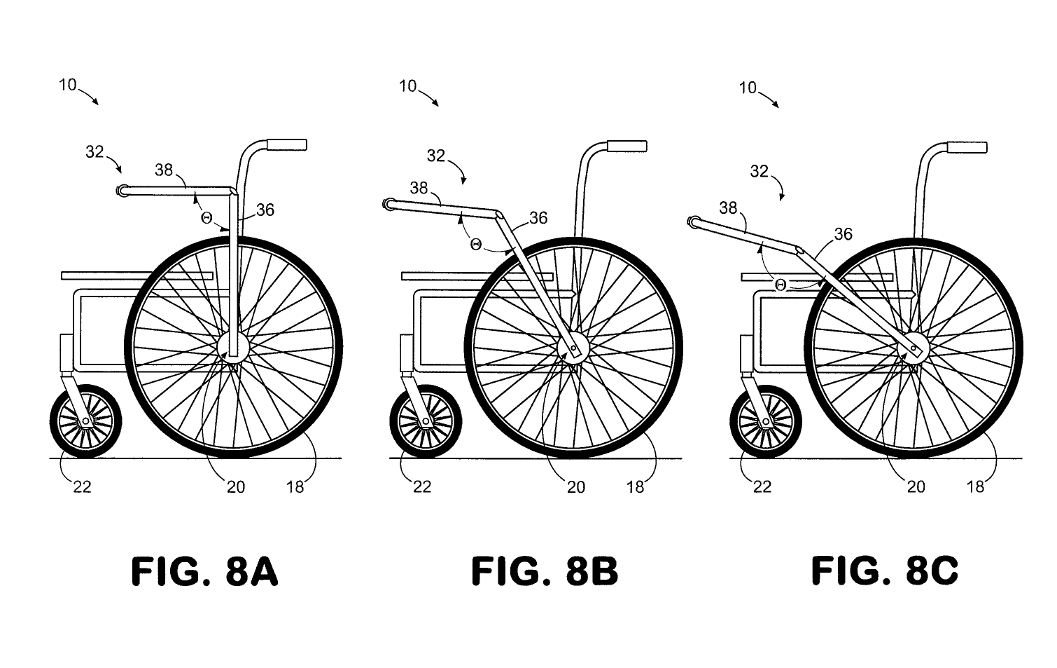

FIGS. 8A-8C illustrate the orientation of the armature 32 during a forward stroke. FIG. 8A shows the armature 32 in an initial or retracted position, for example at the beginning the forward stroke. FIG. 8B shows the armature 32 in a middle position, for example halfway through the forward stroke. FIG. 8C shows the armature 32 in a final or extended position, for example at the end of the forward stroke. As is apparent from those figures, the distal ends of the second arm segments 38 (and the crossbar when provided), and therefore the positions of the user's hands, travel along a substantially horizontal path due to extension of the arms 32 such that the user's hand positions are at nearly the same height throughout the stroke. As is apparent from FIGS. 8A-8C, the arm segments 36, 38 pivot relative to each other such that the angle Θ formed between the segments increases from approximately 90° at the beginning of the forward stroke to just under 180° at the end of the forward stroke. Such horizontal movement is significantly more natural for the wheelchair user than the pure rotational movement of prior propulsion mechanisms and enables the user to drive the wheelchair with greater force through better utilization of the musculature of the upper torso. In addition, due to the widening of the angle between the arm segments 36, 38, the distance from the distal ends of the second arm segments 38 to the wheel axle 20 increases, thereby significantly increasing the leverage or mechanical advantage that the user has over the wheels 18. In some embodiments, the distance from the distal ends to the wheel axles 20 is twice as large as that provided by prior propulsion mechanisms, resulting in twice as much leverage for the user.

The result of the above is that the wheelchair user can propel the wheelchair more easily and more comfortably than previous wheelchairs, with less risk of shoulder injury. Notably, further advantages can be recognized from the extension of the arms 32. For example, due to the increased leverage afforded by the above-described wheelchair, persons having only one arm or only having control over one arm can still propel themselves. In addition, if the wheelchair user recently lost full use of one of his or her arms, for example due to stroke, the wheelchair can be propelled primarily using the fully functional arm with the other arm acting as a follower. Over time, such two-handed operation of the wheelchair may rehabilitate the “bad” arm through muscle re-education.

Although particular embodiments have been described above, it is to be understood that those embodiments are mere example implementations of the disclosed systems and methods. Accordingly, other embodiments are possible and all such embodiments are intended to fall within the scope of this disclosure. One example of another embodiment includes an embodiment in which several gears are provided on one or both sides of the wheelchair such that the wheelchair can be driven in different “speeds” in similar manner to a multi-speed bicycle.

1. A wheelchair comprising:
a wheel;
a gear mechanism associated with the wheel, the gear mechanism being configured to drive the wheel in at least one direction; and
an armature connected to the gear mechanism, the armature being configured to be manipulated by a user of the wheelchair during a propulsion stroke to drive the gear mechanism, wherein the armature is further configured such that the user's hands traverse a substantially horizontal path throughout the propulsion stroke so that the height of the user's hands does not significantly change throughout the stroke.

2. The wheelchair of claim 1, wherein the wheel comprises one of two main wheels of the wheelchair.

3. The wheelchair of claim 1, wherein the gear mechanism comprises a drive gear and a toothed member that together operate as a ratchet device.

4. The wheelchair of claim 1, wherein the armature comprises a lateral arm that extends from the gear mechanism, the lateral arm being extensible so as to increase in length as the armature is moved away from the user.

5. The wheelchair of claim 4, wherein the lateral arm includes a first arm segment and a second arm segment that are pivotally connected to each other at a hinge.

6. The wheelchair of claim 5, wherein the arm segments form an angle between each other that continually increases during a forward propulsion stroke such that the angle is relatively small at an initial position of the forward propulsion stroke and relatively large at an end position of the forward propulsion stroke.

7. The wheelchair of claim 1, wherein the armature comprises two lateral arms, each lateral arm including a first arm segment and a second arm segment that are pivotally connected together, the armature further including a crossbar that extends between distal ends of the lateral arms.

8. A wheelchair comprising:
a wheel;
a gear mechanism associated with the wheel, the gear mechanism being configured to drive the wheel in at least one direction, the gear mechanism including an electronically-controlled actuator that is configured to control a direction in which the wheel can be driven; and
an armature connected to the gear mechanism, the armature being configured to be manipulated by a user of the wheelchair during a propulsion stroke to drive the gear mechanism.

9. The wheelchair of claim 8, wherein the wheel comprises one of two main wheels of the wheelchair.

10. The wheelchair of claim 8, wherein the gear mechanism further comprises a drive gear and a toothed member that together operate as a ratchet device.

11. The wheelchair of claim 10, wherein the actuator is used to change the orientation of the toothed member.

12. The wheelchair of claim 8, wherein the actuator is a solenoid actuator.

13. The wheelchair of claim 8, wherein the actuator comprises a shaft that can be selectively extended from and retracted into a housing of the actuator.

14. The wheelchair of claim 8, further comprising a controller that can be used by the wheelchair user to control the direction in which the wheel can be driven.

15. The wheelchair of claim 14, wherein the controller is mounted to the armature.

16. The wheelchair of claim 14, wherein the controller can be used to select forward motion, rearward motion, left turn, and right turn.

17. A wheelchair comprising:
two main wheels;
a gear mechanism associated with each wheel, each gear mechanism being configured to drive its associated wheel in at least one direction, each gear mechanism including a drive gear and a toothed member that together act as a ratcheting device, each gear mechanism further including an electronically-controlled actuator that is configured to adjust an orientation of the toothed member to control a direction in which the associated wheel can be driven; and
an armature configured to be manipulated by a user of the wheelchair during a propulsion stroke to drive the gear mechanism, the armature including opposed lateral arms, one lateral arm connected to each gear mechanism, each lateral arm including a first arm segment and a second arm segment that are pivotally connected to each other at a hinge, each lateral arm being extensible through relative movement of the first and second arm segments such that each lateral arm increases in length as the armature is moved away from the wheelchair user.

18. The wheelchair of claim 17, wherein the actuator is a solenoid actuator.

19. The wheelchair of claim 17, wherein the actuator comprises a shaft that can be selectively extended from and retracted into a housing of the actuator.

20. The wheelchair of claim 17, further comprising a controller that can be used by the wheelchair user to control the direction in which each wheel can be driven.

21. The wheelchair of claim 20, wherein the controller is mounted to the armature.

22. The wheelchair of claim 17, wherein the first and second arm segments form an angle between each other that continually increases during a forward propulsion stroke such that the angle is relatively small at an initial position of the forward propulsion stroke and relatively large at an end position of the forward propulsion stroke.

23. A wheelchair propulsion mechanism comprising:
an armature configured to be manipulated by a user of the wheelchair during a propulsion stroke to drive at least one wheel of the wheelchair, the armature including opposed lateral arms, each arm associated with one wheel axle, each arm including a first arm segment and a second arm segment that are pivotally connected to each other at a hinge, each lateral arm being extensible through relative movement of the first and second arm segments such that each lateral arm increases in length as the armature is moved away from the wheelchair user.

24. The propulsion mechanism of claim 23, wherein the first and second arm segments form an angle between each other that continually increases during a forward propulsion stroke such that the angle is relatively small at an initial position of the forward propulsion stroke and relatively large at an end position of the forward propulsion stroke.

25. The propulsion mechanism of claim 24, wherein the angle at the initial position is approximately 90°.

26. The propulsion mechanism of claim 24, wherein the angle never reaches or exceeds 180°.

27. The propulsion mechanism of claim 24, wherein the angle reaches a maximum of approximately 170° to 175°.

28. The propulsion mechanism of claim 23, wherein at least one of the first and second arm segments is telescopic such that its length can be adjusted to suit the size of the wheelchair user.

29. The propulsion mechanism of claim 23, further comprising a gear mechanism associated with each wheel, each gear mechanism being configured to drive its associated wheel in at least one direction in response to selections made by the wheelchair user with a controller provided on the armature.

30. The propulsion mechanism of claim 29, wherein each gear mechanism includes a drive gear and a toothed member that together act as a ratcheting device, each gear mechanism further including an electronically-controlled actuator that is configured to, responsive to an electrical signal provided by the controller, adjust an orientation of the toothed member to control a direction in which the associated wheel can be driven.
